(19) United States
(12) Patent Application Publication
(10) Pub. No.: US 2022/0106956 A1
(43) Pub. Date: Apr. 7, 2022

(54) Valve Unit, Capacity Control System and Axial Piston Machine with Such

(71) Applicant: Liebherr Machines Bulle SA, Bulle (CH)

(72) Inventor: Patrick WOHLHAUSER, Giffers (CH)

(21) Appl. No.: 17/490,332

(22) Filed: Sep. 30, 2021

(30) Foreign Application Priority Data
Oct. 6, 2020 (CH) 01268/20

(51) Int. Cl. F04B 49/22; F04B 49/08; F04B 53/10; F16F 1/12; F16K 3/18; F16K 3/34; F16K 17/04; F16K 17/06

(52) U.S. Cl. CPC F04B 49/22; F04B 49/08; F04B 53/10; F16K 17/06; F16K 3/18; F16K 3/34; F16K 17/0473; F16F 1/121

(57) ABSTRACT

The invention relates to a hydraulic valve unit for the power or torque regulation comprising a first valve having a control piston displaceably supported in a first valve housing and a second valve coaxially arranged to the first valve and having a pressure piston displaceably supported in a second valve housing. A working pressure applied to a working connection can be reduced to a control pressure applied to a control connection by means of the valve unit in dependence on the position of the control piston. The control piston is preloaded by a setting spring arranged in the first valve. In accordance with the invention, the control piston and the pressure piston are connected to one another with force transmission by an elastic element, with the elastic element being adapted to transmit a force acting on the pressure piston onto the control piston. A first characteristic spring for generating a characteristic for the power or torque regulation is additionally arranged between the control piston and the pressure piston, with the first characteristic spring being adapted to exert a force from a specific displacement of the pressure piston by a first distance onward. The invention further relates to a power regulation system having a valve unit in accordance with the invention and an axial piston machine having such a power regulation system.

The present invention relates to a valve unit in accordance with the preamble of claim 1 and to a power regulation system having such a valve unit and to an axial piston machine having such a power regulation system.

Axial piston machines are used in many cases in hydraulic systems and are used in a large number of mobile work machines such as hydraulic excavators. Axial piston machines can act as axial piston motors or as axial piston pumps depending on whether a mechanically driven drive shaft is used for conveying hydraulic fluid, in particular hydraulic oil (pump function), or vice versa (motor function).

To protect axial piston machines and the remaining components in the hydraulic system from overloads and, for example, to limit certain parameters such as the working pressure, it is known to use systems for power or torque regulation that act on the axial piston machine or on its pivotable swash plate. Such systems typically comprise complicated arrangements of hydraulic adjustment devices that are frequently only adaptable or settable in a laborious manner. Such regulation systems furthermore often take up considerable construction space in direct proximity to the regulated axial piston machine, which makes a flexible, modular arrangement of a plurality of axial piston machines more difficult.

It is therefore the object of the present invention to provide an apparatus for power or torque regulation of an axial piston machine that has an increased modularity and a simple settability. It is furthermore an objective of the invention to provide an axial piston machine designed with such an apparatus that is simply flexibly installable and simple to set.

This object is achieved in accordance with the invention by a valve unit having the features of claim 1. A hydraulic valve unit is accordingly provided for the power or torque regulation that comprises a first valve having a control piston displaceably supported in a first valve housing and a second valve having a pressure piston displaceably supported in a second valve housing. A working pressure applied to a working connection can be reduced to a control pressure applied to a control connection by means of the valve unit in dependence on the position of the control piston. The control piston is here preloaded by a setting spring arranged in the first valve. The first and second valves are arranged coaxially with one another. The working pressure is in particular the working pressure of the axial piston machine.

In accordance with the invention, the control piston and the pressure piston are connected to one another with force transmission by an elastic element, with the elastic element being adapted to transmit a force acting on the pressure piston onto the control piston. A first characteristic spring for generating a characteristic for the power or torque regulation is additionally arranged between the control piston and the pressure piston, with the first characteristic spring being adapted to exert a force from a specific displacement of the pressure piston by a first distance onward. The first characteristic spring is preferably arranged coaxially to the elastic element. The force exerted by the first characteristic spring in particular acts on the pressure piston, preferably in the direction facing away from the control piston.

It is inter alia possible by the use of an elastic element for the force transmission from the pressure piston to the control piston to adapt the distance of the first and second valves from one another or to set it as required. This can take place by an ex works preconfiguration or where necessary also in the installed state. The use of at least one characteristic spring furthermore enables the generation of a characteristic for the power or torque regulation. The combination with the elastic element enables a simple adaptation of the characteristic, for example by changing the distance of the first and second valves and/or by changing the preload of the setting spring.

On a use of only one characteristic spring, a characteristic results having two linear straight line sections and one inflection point that corresponds to the displacement of the pressure piston by the first distance at which the characteristic spring abuts its abutment and moves into force closure.

The coaxial arrangement of the two valves provides a simple settability in the installed state and an uncomplicated installation. A comparatively small radial extent of the valve unit furthermore thereby results. It is possible by a skillful arrangement of the valve unit relative to the regulated axial piston machine to bound the construction space such that a flexible arrangement, in particular a tandem arrangement, of a plurality of axial piston machines is made possible.

Advantageous embodiments of the invention result from the dependent claims and from the following description.

The force exerted by the first characteristic spring on a displacement of the pressure piston going beyond the first distance in particular acts on the pressure piston in a direction that is directed away from the control piston. With an “activated” first characteristic spring for a displacement of the pressure piston by a certain distance, a higher force thereby has to be exerted than without an action of the first characteristic spring. An inflection point of the characteristic in the pressure stroke diagram thereby results that approximates the hyperbola for the power or torque regulation. The first characteristic spring in particular moves into a force closure with a housing of the valve unit or of the second valve on a contact with its abutment.

Provision is made in an embodiment that the elastic element is a spring that is fastened to the pressure piston and that preferably urges a spring carrier toward the control piston. The compression spring in particular has a smaller spring constant than the first characteristic spring. The compression spring is preferably longer than the first characteristic spring.

Provision is made in a further embodiment that the first characteristic spring is arranged around the elastic element and is guided within a first bore whose depth is greater than the length of the relaxed first characteristic spring, with the first characteristic spring contacting the base of the first bore on a displacement of the pressure piston by the first distance. The base acts as an abutment for the first characteristic spring. The first bore preferably has a central cutout through which the elastic element and/or the control piston is guided. The first bore here does not have to be a bore in a housing of the valve unit, but can rather also represents a bore in a housing part or in a sleeve of the second valve.

Provision is made in a further embodiment that a second characteristic spring is furthermore arranged between the control piston and the pressure piston, said second characteristic spring contributing to the generation of the characteristic for the power or torque regulation and being adapted to exert a force from a displacement of the pressure piston by a second distance onward, with the second distance being longer than the first distance and with the second characteristic spring preferably being arranged coaxially to the first characteristic spring and/or to the elastic element. The force exerted by the second characteristic spring in particular acts, as already with the first characteristic spring, on the pressure piston and preferably in the direction facing away from the control piston. More than two characteristic springs can naturally also be provided that successively abut their abutments and move into force closure on a displacement of the pressure piston.

On a solution with two characteristic springs, a characteristic results with three linear straight line sections and two inflection points that correspond to the displacements of the pressure piston by the first and second distances at which the characteristic springs abut n their respective abutment and move into force closure. A characteristic having two inflection points can be advantageous since, with a larger number of inflection points, the respective characteristic change or change of the straight line pitches is less pronounced at these inflection points. In addition, a better approximation of the characteristic to a real hyperbola is achieved by a larger number of characteristic springs or inflection points.

Provision is made in a further embodiment that the pressure piston has a pressure piston control surface at which the working pressure is applied and exerts a force in the direction of the control piston, with a first restrictor for reducing pressure fluctuations at the pressure piston control surface being arranged between the pressure piston control surface and the working connection. The restrictor prevents a pressure pulsation caused by the opening or closing of the first valve from acting on the pressure piston control surface.

Provision is made in a further embodiment that the control piston has a control piston control surface to which the control pressure generated by the valve unit is applied and exerts a force in the direction of the setting spring. The control pressure therefore supports the surface that is exerted by the pressure piston on the control piston.

Provision is made in a further embodiment that the reduction of the working pressure to the control pressure is determined by the position of the control piston, with the control piston having a first control edge that permits a hydraulic fluid flow from the working connection to the control connection on an opening. An opening of the first control edge results in an increase of the control pressure that is present at the control connection. A force effect that urges the control piston into s closing position of the first control edge is in particular increased by the increase of the control pressure. A displacement of the control piston in the direction of the setting spring preferably results in a closing of the first control edge.

It must be noted here that strictly speaking the combination of an edge of the piston and an associated edge of the surrounding housing forms the actual control edge. For reasons of simplicity, however, the term “control edge” is used for the edge of the piston in the following.

In a further embodiment, a common tank connection is provided via which hydraulic fluid leaks of both valves can be led off into a hydraulic tank. The common tank connection is preferably provided in a common housing of the valve unit. The tank connection is furthermore preferably connected to a characteristic spring chamber in which the elastic element and/or the first characteristic spring is/are stored. The term characteristic spring chamber is here not to be understood as restrictive in the sense that a characteristic spring necessarily has to be present therein. It can in this respect rather also be any desired chamber of the valve unit or of a common housing or also of a housing of one of the two valves into which the leaks of the two valves flow. A second tank connection can thereby be dispensed with, which saves costs in the production.

Provision is made in a further embodiment that the setting spring is stored in a setting spring chamber that is connected to the tank connection via a longitudinal bore extending in the control piston, with the longitudinal bore extending as a blind hole bore from the end facing the characteristic spring chamber into the control piston and with a first radial bore or directional bore being provided in the control piston and opening into the longitudinal bore from its outer side. There is preferably a fluid connection via the radial or directional bore and the longitudinal bore between the setting spring chamber and the characteristic spring chamber via which fluid leaks can flow off. The radial or directional bore preferably comprises a second restrictor or is alternatively configured such that the bore exerts a restrictive effect. A damping of the functional movement of the control piston is thereby achieved.

Provision is made in a further embodiment that the control piston has a second control edge that permits a hydraulic flow from the control connection to the tank connection on an opening, preferably via a longitudinal bore extending in the control piston and at least one second radial or directional bore starting from the longitudinal bore. On an opening of the second control edge, the control pressure to a hydraulic tank is relieved, in particular via a common tank bore that likewise serves the leading off of fluid leaks of both valves.

Provision is made in a further embodiment that the first and second valves are arranged in a common housing, with the first valve preferably being arranged in a first conical bore, in particular a stepped bore, and the second valve preferably being arranged in a second conical bore, in particular stepped bore and being able to be introduced into the housing from the outside. A simple installation capability and accessibility of the two valves thereby results. The first and/or second valve(s) can thereby be installed in the housing as a premounted assembly, for example in cartridge form, and can be reached or replaced or set simply during the operation of the power regulation.

The first and second valves preferably each comprise a screw-in housing so that they can be screwed into the housing of the valve unit from the outside. The screw-in housing can represent the first and/or second valve housing(s) or a portion thereof.

Provision is made in a further embodiment that the first and second valves can be installed in the housing as premounted assemblies and is/are preferably designed in cartridge form.

Provision is made in a further embodiment that the preload of the setting spring is changeable or settable, with the first valve housing preferably comprising a setting screw to which the setting spring is fastened. The distance of the setting screw and thus the distance of the fastening point of the preloaded setting spring from the second valve can be varied by screwing or unscrewing the setting screw into/out of a threaded bore of the first valve housing. The setting screw is preferably fixable by means of a nut. The preload of the setting spring is reduced and thus the regulation start of the valve unit in accordance with the invention is displaced toward lower working pressures by unscrewing the setting screw. The preload can conversely be increased by screwing in the setting spring. The regulation then only takes place at higher working pressures. The characteristic of the power or torque regulation can thereby be varied, with in particular a parallel displacement of the characteristic resulting in the pressure/stroke diagram.

Provision is made in a further embodiment that the second valve housing is configured such that its distance from the first valve is not variable. Provision can, for example, be made that the second valve housing is or comprises a screw-in housing, whereby the second valve can be screwed into a bore of the housing of the valve unit. An abutment or overhang can here by provided at the second valve housing to tension and fix the second valve with respect to the housing of the valve unit.

Provision is made in a further embodiment that the first and/or second valve housing(s) is/are or comprises/comprise a screw-in housing that is configured such that the distance of the screw-in housing is adjustable and is in particular fixable by a nut. The characteristic for the power or torque regulation can be varied by adjusting the distance of the screw-in housing of the corresponding valve from the respective other valve to in particular compensate a change of the preload of the setting spring.

Provision is made in a further embodiment that the working pressure is supplied both to the control piston and to the pressure piston. The valve unit preferably has a common housing having a common working connection from which the hydraulic fluid is supplied to both pistons. Both inflows can be separated by a first restrictor to reduce pressure fluctuations at the pressure piston.

In a further embodiment, a first pressure generation means is provided by means of which an additional, settable pressure can be exerted on the control piston, with the first pressure generating means preferably comprising a control surface of the control piston, a pressure reducing unit, and/or an actuator, in particular a proportional magnet or actuating motor. An additional, operationally variable force can thereby be exerted on the control piston to be able to flexibly adapt the regulation parameters of the valve unit.

In a further embodiment, a second pressure generation means is provided by means of which an additional, settable pressure can be exerted on the control piston, with the second pressure generating means preferably comprising a control surface of the control piston, a pressure reducing unit, and/or an actuator, in particular a proportional magnet or actuating motor. An additional, operationally variable force can thereby be exerted on the control piston to be able to flexibly adapt the regulation parameters of the valve unit.

Provision is made in a further embodiment that the elastic element is a characteristic spring having a non-linear spring constant. The elastic element thereby also contributes to the generation of the characteristic.

The present invention further relates to a hydraulic power regulation system for an axial piston machine having a valve unit in accordance with the invention and a hydraulic adjustment device. The control pressure generated by the valve unit is applied as an input value to the adjustment device that is preferably a volume flow control valve or a volume flow regulation valve The power regulation system can be used for the power or torque regulation of an axial piston machine.

Provision is made in an embodiment of the power regulation system that the adjustment device has a valve piston that is displaceably supported in a third valve housing and to which the control pressure is applied, with the valve piston being connected with force transmission to a displaceably supported adjustment piston, in particular via a feedback spring. The information on the position of the setting piston or of a setting lever of the axial piston machine connected thereto is thereby simply transmitted to the power regulation system.

Provision is made in a further embodiment of the power regulation system that the adjustment device has a working connection to which the working pressure of the axial piston machine is applied, with the working pressure being able to be reduced in dependence on the position of valve piston by means of the adjustment device to a setting pressure that is applied to the setting piston and that exerts a force directed away from the valve piston thereon, and with the setting pressure preferably being applied to both sides or to correspondingly formed valve piston control surfaces of the valve piston having the same area so that a movement of the valve piston is independent of the amount of the setting pressure.

Provision is made in a further embodiment of the power regulation system that the first and second valves of the valve unit and the adjustment device are arranged in a common housing part, in particular a connection plate of an axial piston machine, with the longitudinal axes of the first and second valves preferably being oriented perpendicular to the longitudinal axis of the adjustment device. An advantageous and space saving arrangement of the respective components at the axial piston machine thereby results.

The present invention further relates to an axial piston machine, in particular to an axial piston motor or an axial piston pump, having a power regulation system in accordance with the invention. The axial piston machine comprises a swash plate pivotably supported in a housing of the axial piston machine, a setting lever connected to the front side of the swash plate for adjusting the pivot angle of the swash plate, and a return device that is arranged on the rear side of the swash plate and that exerts a force on the rear side of the swash plate. The end of the setting lever opposite the swash plate is here connected to the setting piston of the adjustment device so that the pivot angle of the swash plate results from the sum force acting on the setting piston. The return device is in particular a return spring.

A connection plate is provided in an embodiment, of the axial piston machine, with the adjustment device being arranged in a bore of the connection plate and preferably being designed in cartridge form, with the valves of the valve unit being arranged in a housing installed at the connection plate or in the connection plate, and with the housing or the connection plate preferably being configured such that the valve unit does not project beyond a connection surface formed at a rear side of the connection plate remote from the swash plate so that a second axial piston machine can be installed at the connection surface over its connection surface for forming a tandem arrangement having a common drive shaft.

The present invention furthermore relates to a mobile working machine having at least one axial piston machine in accordance with the invention. In this respect, the same advantages and properties obviously result as for the axial piston machine in accordance with the invention or for the power regulation system in accordance with the invention, and for the valve unit in accordance with the invention so that a repeat description will be dispensed with at this point.

Further features, details, and advantages of the invention result from the embodiments explained in the following with reference to the Figures. There are shown:

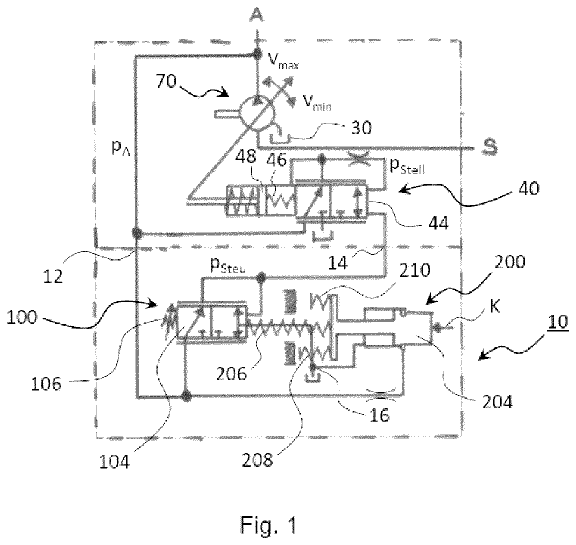

FIG. 1: a circuit diagram of the power regulation system in accordance with the invention of an axial piston machine in accordance with an embodiment;

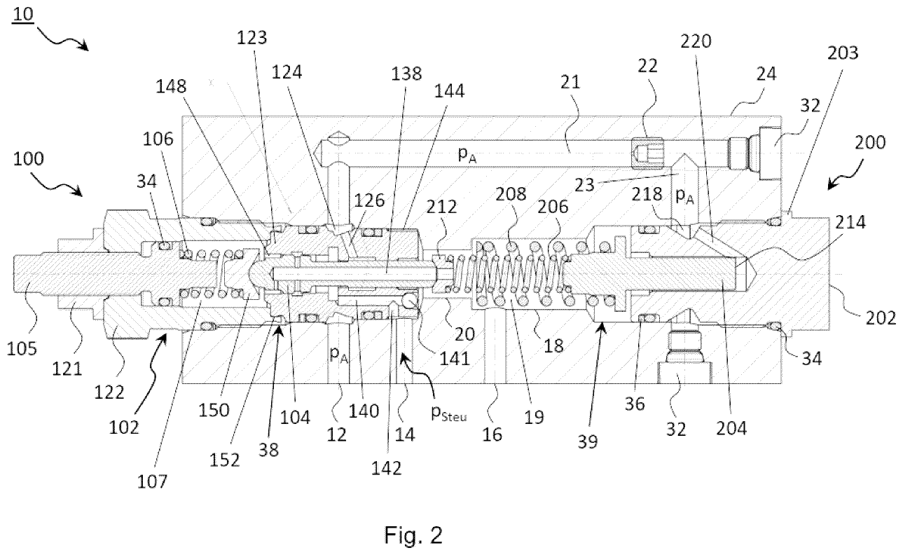

FIG. 2: a longitudinal section through the valve unit in accordance with the invention in accordance with an embodiment;

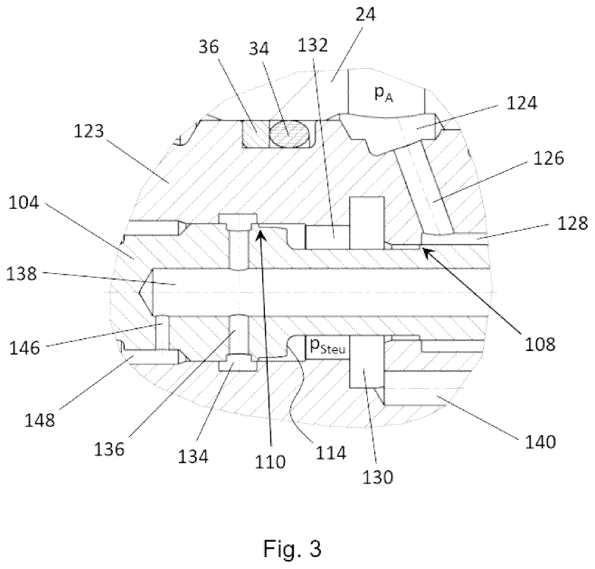

FIG. 3: an enlarged detail of the control piston of the valve unit in accordance with FIG. 2;

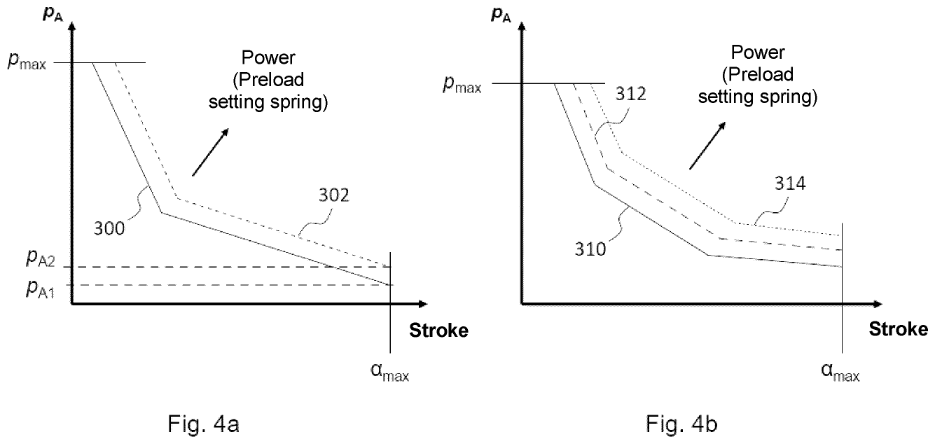

FIGS. 4a-:b two examples for characteristics that can be generated by the valve unit in accordance with the invention;

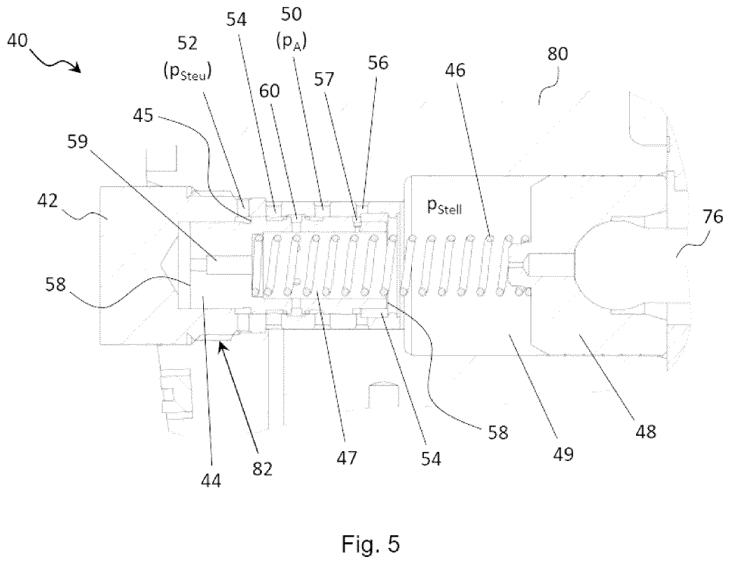

FIG. 5: a longitudinal section through the adjustment device of the power regulation system in accordance with the invention in accordance with an embodiment;

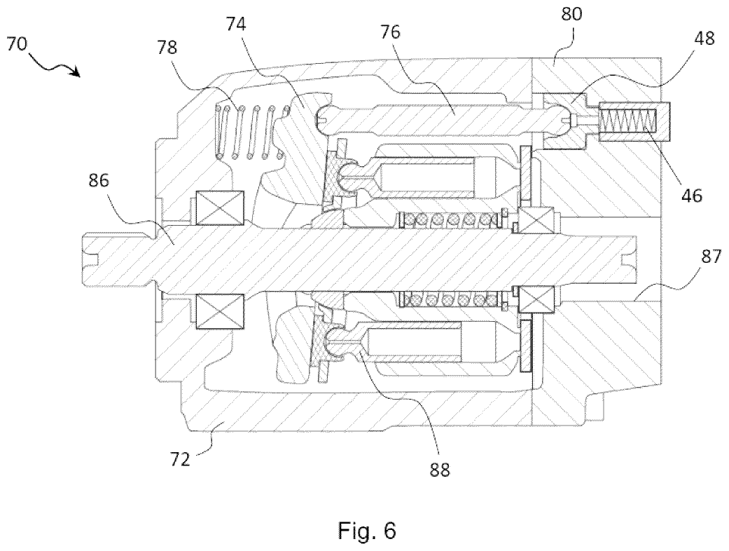

FIG. 6: a longitudinal section through an axial piston machine in accordance with the invention in accordance with an embodiment;

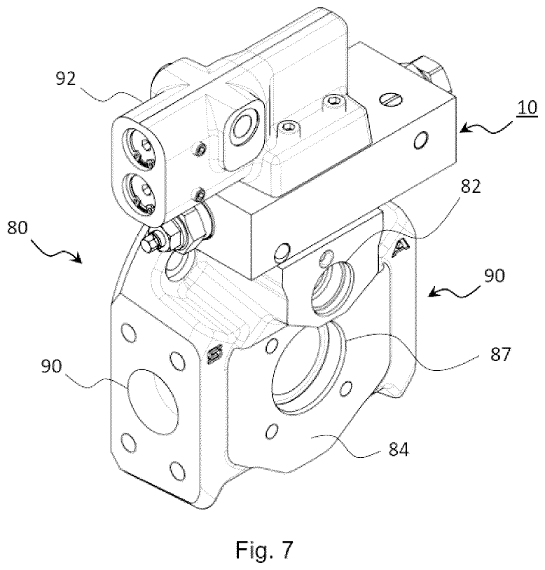

FIG. 7: the connection plate of an axial piston machine in accordance with the invention in accordance with an embodiment in a perspective view; and

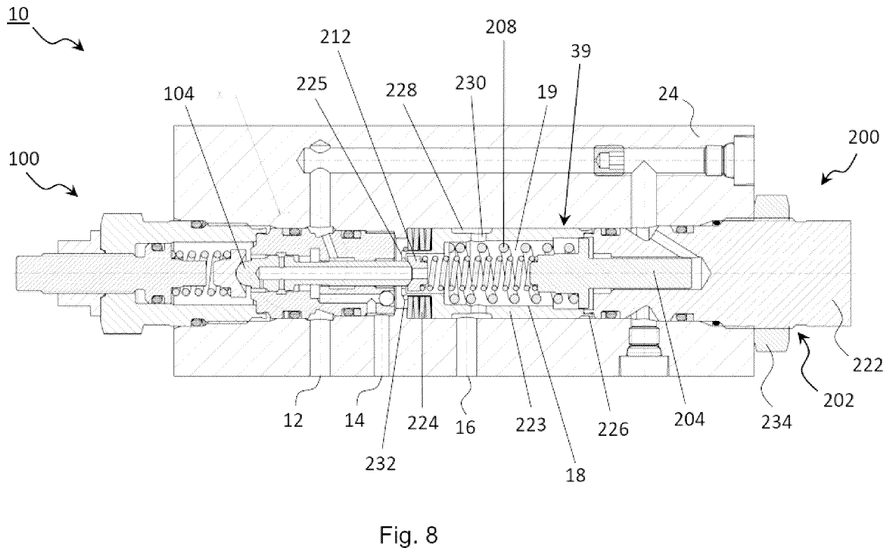

FIG. 8: a longitudinal section through a further embodiment of the valve unit in accordance with the invention.

FIG. 1 shows a circuit diagram of the power regulation system in accordance with the invention of an axial piston machine 70 in accordance with an embodiment. The power regulation system comprises a hydraulic valve unit 10 and a hydraulic adjustment unit 40 that is designed as a volume flow control valve and that is coupled to a pivotable swash plate 74 of the axial piston machine 70 via a setting lever 76.

The axial piston machine 70 has a hydraulic working connection A at which the hydraulic working pressure p_{A} is present. This working pressure p_{A} is supplied as an input value both to the valve unit 10 and to the volume flow control valve 40. A control pressure p_{Steu} is produced via the valve unit 10 by a reduction of the working pressure p_{A} that is likewise supplied as an input value to the volume flow control valve 40.

The volume flow control valve 40 has a valve piston 44 to which the control pressure p_{Steu} is applied. In dependence on the control pressure p_{Steu} or on the position of the valve piston 44, the volume flow control valve 40 reduces the working pressure p_{PA} to a setting pressure p_{Stell} that acts on a setting piston 48 of the volume flow control valve 40 connected to the setting lever 76 of the axial piston machine 70. So that the setting pressure p_{Stell} does not exert any influence on the position of the setting piston 48 or of the setting lever 76, the setting pressure p_{Stell} is supplied to control surfaces 58 of equal sizes (cf. FIG. 5) on both (front) sides of the valve piston 44.

A displacement of the setting lever 76 results in a pivoting of the swash plate 74 and thus in a changing of the pivot angle. The maximum and minimal pivot angles of the swash plate 74 correspond to maximum and minimal conveying volumes Vₘₐₓ and Vₘᵢₙ.

The valve unit 10 in accordance with the invention comprises two hydraulic valves 100 and 200 whose longitudinal axes extend coaxially to one another. The first valve 100 accommodates a control piston 104 and a pressure piston 204 is located in the second valve 200, with a mechanical, force-transmitting connection being present between these two pistons 104, 204. A force that is generated by a preloaded setting spring 106 acts on the control piston 104 in the direction of the pressure piston 204. Further external forces K can engage at the control piston 104 and/or at the pressure piston 204.

The working pressure p_{A} of the axial piston machine 70 is supplied as an input value to both valves 100, 200. The pressure piston 204 has a control surface 214 for the working pressure p_{A} that is directed such that the working pressure p_{A} exerts a force effect in the direction of the control piston 14 on the pressure piston 204. The mechanical connection between the pressure piston 204 and the control piston 104 is an elastic connection that is guided via a compression spring 206. This compression spring 206 transmits the total force acting on the pressure piston 204 to the control piston 104 and is likewise oriented coaxially to the valves 100, 200 or to the control and pressure pistons 104, 204.

A control pressure p_{Steu} is generated via the valve unit 10 in dependence on the position of the control piston 104 by reducing the working pressure p_{A}. The control pressure p_{Steu} can be increased by opening a first control edge 108 (cf. FIG. 2) of the control piston 104. Depending on the opening width, a pressure level of the control pressure p_{Steu} results considerably below the level of the working pressure p_{A}, an only slightly reduced pressure level, etc. Provision can also be made that the control pressure p_{Steu} is equal to the working pressure p_{A} at a maximum opening. The control pressure p_{Steu} can be relieved toward a hydraulic tank 30 via a second control edge 110 of the control piston 104. The opening, closing, and remaining in position of the control edges 108, 110, i.e. the movement of the control piston 104 takes place in accordance with a characteristic (in particular a force/path length change characteristic 300, 310, cf. FIGS. 4a-b) for the power or torque regulation of the axial piston machine 70.

In the embodiments discussed in the following, the first and second valves 100 and 200 are located in a common housing 24, with arrangements in separate and in particular connectable housings of the valve unit 10 also being conceivable. The housing 34 has three pressure connections 12, 14, 16, and indeed a working connection 12 for the supply of the working pressure p_{A}, a control connection 14 for the regulation and control pressure p_{Steu}, and a tank return 16 for the relief of the control pressure p_{Steu} and for the common leading off of the hydraulic fuel leaks of both valves 100, 200.

In accordance with the invention, at least one characteristic spring for generating the previously addressed characteristic 300, 310 is located between the pressure piston 204 and the control piston 104. The circuit diagram shown in FIG. 1 shows an embodiment of the valve unit 10 that is equipped with two characteristic springs 208, 210

In a first observation, the movement of the control piston 104 should be neglected. In the state shown, the force closure between the pressure piston 204 and the control piston 104 is only present via the long compression spring 206. As soon as the sum force (resulting in the present case from the working pressure p_{A} and the possibly present further forces K, with the latter only being optional, as will be explained further below) that acts on the pressure piston 204 and that effects its movement in the direction of the control piston 104 is correspondingly large so that the longer (the lower in the circuit diagram) characteristic spring 208 contacts its support surface, this sum force has to act against the return force of two springs, namely of the compression spring 206 and of the characteristic spring 208. From this position of the pressure piston 204 onward, the additional displacement of the pressure piston 204 achieved hereby will consequently be smaller with the again same increase in the sum force. The first characteristic spring 208 contacts the support surface as soon as the pressure piston 204 has been moved by a first distance. As soon as the shorter (the upper in the circuit diagram) third characteristic spring 210 impacts its support surface, the corresponding circumstances are repeated.

A force/distance change characteristic 310 thus results for the previously observed arrangement having two characteristic springs 208, 210 that consists of three mutually adjacent straight line sections (cf. FIG. 4b). In accordance with this design of the characteristic 310, the actual power hyperbola that results from the relation p_{A} * Q=const .is approximated by three straight line sections, where Q is the volume flow of the hydraulic fluid at the working connection A or at the suction connection S of the axial piston machine 70-

In a simple embodiment, only the return forces of the compression spring 206 and characteristic spring(s) 208, 210 located in force closure and the working pressure p_{A} applied on its control surface 214 act on the pressure piston 204 and the sum force K additionally engaging at the pressure piston 204 has the value of zero.

A settable compression spring that is called a setting spring 106 from now on is located on the front side of the control piston 104 remote from the pressure piston 204. A reinforcement of the preload of the setting spring 106 has the consequence that the force to be applied to the pressure piston 204 again has to become larger in the direction of the control piston 104 to urge the control piston 104 out of its position of rest.

In anticipation of the following explanations, it must be mentioned that the regulation start is set via the preload of the setting spring 106, i.e. a pressure level p_{A1}, p_{A2} is fixed for the working pressure p_{A} (cf. FIG. 4) from whose reaching onward, a self-acting larger pivoting back of the swash plate 74 is triggered for an increasing overshoot.

In the position of the control piston 104 shown in FIG. 1, the first control edge 108 of the valve 100 has the position of maximum opening so that the starting parameter of the valve unit 10, the control pressure p_{Steu}, corresponds to the working pressure p_{A} that is supplied to the volume flow control valve (only a valve 40 in the following) connected hydraulically downstream. The control pressure p_{Steu} is furthermore also supplied to a control surface of the control piston 104, called a control piston control surface 114 in the following, that is aligned such that the force thereby exerted on the control piston 104 supports the force supplied to the pressure piston 204 via the compression spring 206. The circuit diagram furthermore indicates the feature that the leaking of both valves 100, 200, including the pressure relief of the control pressure p_{Steu}, moves via a characteristic spring chamber into a common tank return or tank connection 16.

The valve 40 has a working connection 50 (cf. FIG. 5) that has a fluid connection to the setting piston chamber 49 of the axial piston machine 70. (i) a fluid connection between the working connection 50 for the working pressure p_{A} and the setting piston chamber 49, (ii) a fluid connection between the tank 30 and the setting piston chamber 49, or (iii) the setting piston chamber 49 is connected neither to the working connection 50 nor to the tank 30 (neutral position) results in dependence on the valve piston position via two control edges of the volume flow control valve 40 The position of the valve piston 44 results through the respective equilibrium of forces of the return force of the feedback spring 46 and the control pressure p_{Steu} present on its valve piston control surface 45. As shown in the circuit diagram, the setting pressure p_{Stell} is supplied via a restrictor to the front valve piston side remote from the setting piston chamber 49. It is hereby achieved that the setting pressure p_{Stell} does not have any influence on the valve piston position. The latter relates to the design embodiment of the adjustment device 40 looked at in the following in which the setting pressure p_{Stell} is applied to the valve piston cross-section facing the setting piston chamber 49.

As can be recognized, the feedback spring 46 is supported between the valve piston 44 and the setting piston 48. The information on the position of the setting piston 48 or the information on the instantaneous value of the driving mechanism piston stroke of the axial piston machine 70 hereby goes back to the power regulation system in accordance with the invention.

A longitudinal section through an embodiment of the valve unit 10 in accordance with the invention is shown in FIG. 2, with only one characteristic spring 208 being present unlike in the solution shown in FIG. 1.

The valves 100 and 200 are arranged in a common housing 24 and each have a valve housing 102, 202 that is arranged within the housing 24 and in which the pressure and control pistons 104, 204 are displaceably supported. It is achieved via a total of three housing bores or connections 12, 14, 16 that the working pressure p_{A} is supplied to both valves 100, 200 via a working connection 12, with the valve 200 receiving the working pressure p_{A} via a longitudinal bore 21 extending in the housing and via a radial bore 23 leading therefrom to the valve 200. A restrictor 22 is provided in the longitudinal bore 21 for the partial decoupling of the two pressure feeds. The radial bore 23 impacts an outer radial groove 218 of the second valve housing 202 from which a directional bore 220 extends to the pressure piston 204 so that the working pressure is applied to the front side of the pressure piston 204 that is remote from the control piston 104 and that acts as a pressure piston control surface 214. Th radial bore 23 extends due to the production up to the outer side of the housing 24 and is sealed by a closure element 32.

The restrictor 22 prevents a pressure pulsation possibly caused by the opening or closing of a control edge 108, 110 of the valve 100 from acting on the control surface 214 of the pressure piston 204. The installation location shown of the restrictor 22 in the longitudinal bore 21 enables a simple installation. The longitudinal bore is likewise closed by a closure element 32 that is provided due to the construction.

Multi-step blind hole bores or stepped bores 38, 29 that are connected to one another within the housing 24 and in which the valves 100, 200 are arranged are located at the front sides of the common housing 24. As the penetration depth in the housing 24 increases, a respective step-wise reduction of the diameter is present in both stepped bores 38, 39. The valves 100, 200 can thereby be installed or screwed in the housing 24 from the outside as premounted assemblies.

The housing of the second valve 200 (the second valve housing 202 in the following) is configured as a screw-in part or as a screw-in housing and is centered in the housing 24 via a threaded connection and is fixed in cooperation with an annular overhang 203 that is tensioned with the housing surface in the end position of the installation. As can be recognized, no manual adjustment of the preload of the compression spring 206 that is in force closure is possible from the outside by this constructively simple solution since there is only a fixed, non-adjustable abutment by the overhang 203. The preload can, however, be achieved via the use of further components having different axial dimensions—with respect to their respective installation lengths—or by the addition of washers or the like.

The elastic element 206 designed as a preloaded compression spring can be recognized in FIG. 2 that is fastened to the front side of the pressure piston 204 facing the control piston 104. A spring carrier 21 that presses against the control piston 104 is located at the end of the compression spring 206 remote from the pressure piston 204. A first characteristic spring 208 that is arranged coaxially to the compression spring 206 and surrounds it is likewise fastened to the pressure piston 204. The compression spring 206 is thinner than the first characteristic spring 208 and thus has a smaller spring constant. The first characteristic spring 208 extends within a first bore 18 that is formed in the embodiment shown in FIG. 2 in the common housing 24. The blind hole base of the bore 18 disposed opposite the pressure piston 204 represents the abutment for the first characteristic spring 208 and has a cutout 20 centrally through which the compression spring 206 extends to the control piston 104. The bore 18 forms a characteristic spring chamber 19.

The pressure piston 204 is guided in the second valve housing 202 and acts on its front surface that is immersed therein and that represents the pressure piston control surface 214 with the working pressure pa. The pressure piston control surface 214 provided for this purpose can naturally also only extend over a partial region of this front surface. The compression and characteristic springs 206, 208 are fixed on the pressure piston 204 at their respective end winding via a corresponding stepped diameter dimension of the pressure piston 204 at its spring contact surfaces. In accordance with this principle, the spring carrier 212 is also fastened to the compression spring 206. Said assembly of the valve 200 can be installed in and removed from the housing 24 as a premounted unit, in particular in cartridge form. The valve housings 102, 202 are sealed toward the outside by a series of seals or sealing rings 34 and support rings 35.

In the position of the pressure piston 204 shown in FIG. 2, the first characteristic spring 208 is not yet in force closure. As soon as this is present on the exceeding of a correspondingly high working pressure pa, i.e. on a displacement of the pressure piston 204 by a first distance, the first characteristic spring 208 is supported at the blind hole base of the bore 18 and unlike the compression spring 206 does not act directly on the control piston 104. On the presence of a force closure of the first characteristic spring 208 (or of optionally provided further characteristic springs 210) that is present between the pressure piston 204 and the housing 24, the compression spring 206 is tensioned less due to the return force of the first characteristic spring 208 so that a smaller force is exerted on the control piston 104 by the pressure piston 204.

Instead of the use shown here of a characteristic spring 208, whereby the theoretical hyperbolic extent of the power hyperbola is approximated by a characteristic line 300 that is only composed of two straight line sections (cf. FIG. 4a), a second characteristic string 210 can also be installed (not shown) by an expansion of the valve 200, whereby a characteristic 310 results that is composed of three straight line sections (cf. FIG. 4b). For this purpose, with respect to the housing 24, the corresponding longitudinal section of the bore 18 can be designed with a larger diameter and a further blind hole base can be worked therein on which the second characteristic spring 210 can be supported. All three springs 206, 208, 210 are then located in a coaxial configuration arranged in one another. The principle shown in the embodiment of the design of the pressure piston 204 that enables an independent fastening of the springs 206, 208, can be continued to enable the fastening of a second characteristic spring 210.

As can be recognized, the total assembly of the second valve 200 comprising the second valve housing 202, the seals 34 with the support rings 35, the pressure piston 204, the compression spring 206, the first characteristic spring 208, and the spring carrier 212 can already be installed outside the housing 24 and can accordingly be installed as a premounted unit in the housing 24 in the embodiment.

The shown positioning of the seal comprising a support ring 35 and a seal ring 34 of the second valve housing 202 formed as a screw-in housing toward the housing surface has a particularly effective seal. The total leaking of the valve 200 via the characteristic spring space 19 can therefore be led off into the tank bore 16 that extends from the outer side of the housing 24 perpendicular to the longitudinal axis of the valve 200 to the characteristic spring space 19 and opens into it.

The housing of the first valve 100 (the first valve housing 102 in the following) comprises a control housing 123 in which the control piston 104 is displaceably supported and a screw-in housing 122 outwardly adjoining it. A setting spring chamber 107 is formed in the latter in which a preloaded setting spring 106 is stored that is supported on the front side of the control piston 104 remote from the pressure piston 204 via a setting spring carrier 150. The setting spring 106 is installed at the end disposed opposite the setting spring carrier 150 at a setting screw 105 that is supported via a threaded bore in the screw-in part 122, that extends outwardly through the screw-in housing 122, and is fixed via a nut 121 there. The preloaded setting spring 106 exerts a force on the control piston 104 that counters the force exerted by the pressure piston 204 due to the working pressure p_{A}. The preload of the setting spring 106 and thereby the working pressure p_{A} at which a movement of the control piston 104 takes place (regulation start), can be varied and set by adjusting the setting screw depth of the setting screw 105, i.e. by screwing in or unscrewing.

The assembly of the valve 100 that comprises the control housing 123, the control piston 104 completely guided therein, the screw-in housing 122, the setting spring 106 accommodated therein, the setting screw 105, the counter nut 121, the setting spring carrier 150, as well as seal rings 34, support rings 35, and a closure element 141 that is installed in the control housing 123 can likewise be inserted into the housing 24 as a premounted unit, in particular in cartridge form. The removal of this assembly is possible, for example, in that there is shape matching between the control housing 123 and the screw-in housing 122 or in that the control housing 123 and the screw-in housing 122 are formed in one piece. The first option that is less complex from a technical production aspect is shown in FIG. 2. The installation of the control piston 104 in the control housing 123 is considerably simpler when the screw-in housing 122 is later attached as a separate part. The jacket surface of the control housing 123 has a swept contour in its end section facing the screw-in housing 122, whereby the screw-in housing 122 can be fastened by a crimping 152.

Leak paths into which the highly pressurized hydraulic fluid can enter extend along the stepped bores 38, 39 so that the seals 35 there are reinforced by support rings 34. In contrast, the setting spring chamber 107 is only outwardly closed by a simple seal 34 because the hydraulic fluid entering into this inner space does not have a high pressure.

The leak present between the control housing 123 and the control piston 104 either flows directly into the characteristic spring chamber 19 or initially into the setting spring chamber 107. The same applies to the leak between the control housing 123 and the housing 24. At the very beginning after an installation of the first valve 100, a small amount of hydraulic fluid can move into the region between the housing 24 and the screw-in housing 122. The seal between the screw-in housing 122 and the housing 24 is very effective at this transition due to the conical design of the stepped bore 38 and the high contact pressure there.

The following leak path is present to enable required leak lead-off from the setting spring chamber 107: In the end region of the control piston 104 facing the setting spring carrier 150, its outer diameter has a considerable under-dimension with respect to the piston bore located in the control housing 123. There is a fluid connection from the wide gap or annular space 148 thereby resulting in the control piston 104 via a radially extending bore or radial bore 146 (cf. FIG. 3) into a longitudinal bore 138 extending centrally in the control piston 104, with the radial bore 146 preferably having a restrictive effect or an installed restrictor. This longitudinal bore 138, that ends within the control piston 104 as a blind hole bore, opens into the front side of the control piston 104 facing the pressure piston 204 and is continued by a central bore in the spring plate 212, whereby a fluid connection exists from the setting spring chamber 107 up to the characteristic line chamber 19. There is a tank connection 16 to a hydraulic tank 30 via a bore from the housing surface into the characteristic spring chamber 19. A restrictor (not drawn for reasons of a better overview) inserted into the radial bore 146 achieves a damping of the functional movement of the control piston 104.

The control housing 123 has a peripheral groove or radial groove 124 having a comparatively large cross-section approximately at its center, said peripheral or radial groove 124 intersecting the housing bore of the working connection 12 via which hydraulic fluid at the working pressure p_{A} enters into the valve unit 10. Starting from this radial groove 124, the hydraulic fluid at working pressure p_{A} is led to the control piston 104 through a slanted radial bore or directional bore 126 that opens into a first inner radial groove 128 of the control housing 123. The fluid connection required for the relief of the control pressure p_{Steu} extends from the region of a second control edge 110 (cf. FIG. 3) over radial bores 134 that each reach up to and into the longitudinal bore 138.

The control pressure bore 14 in the housing 24 impacts an annular space 144 that is present in the housing 24 due to an under-dimension of the control housing 123 with respect to the stepped bore 38. The fluid connection extends from this annular space 144 via a radial bore 142 into the control housing 123 that impacts a longitudinal bore 140 set acentrically there. The latter in turn impacts a second inner radial groove 130.

The longitudinal bore 140 has to be set by a cover surface of the control housing 123 in production. This opening is sealed by a closure element 141.

In FIG. 3, an enlarged detail of the control piston 104 is shown in that region that is marked by the circle marked by X in FIG. 2. As can be recognized, the control piston 104 has a larger diameter at the left side of a control chamber 133 adjacent to the second inner radial groove 130, whereby a control piston control surface 114 and thus a force effect of the control pressure p_{Steu} results on the control piston 10+4 that conforms to the circuit diagram representation (FIG. 1) and the explanation provided hereon. The control piston 104 has two control edges 108, 110 that cooperate with corresponding edges of the control housing 123 in dependence on the position of the control piston 104.

In the representation in accordance with FIG. 3, the control piston 104 has a position in which both control edges 108, 110 are closed, i.e. the power or torque regulation of the axial piston machine 70 is in a stationary state. While maintaining the setting of the setting spring 106, a reduction in the force transmitted from the pressure piston 204 to the control piston 104 results in a displacement of the control piston 104 to the right (in the direction of the pressure piston 204), which triggers an opening of the first control edge 108 and thus an increase in the control pressure p_{Steu}. A fluid connection between the first inner radial groove 128 in which the working pressure p_{A} is always present and the control chamber 123 is produced in this process. Due to the increase in the control pressure p_{Steu}, a force effect is increased that urges the control piston 104 to the left into the closed position of the first control edge 108 because—as already mentioned—there is a correspondingly directed control piston control surface 114 in the control chamber 132.

Starting from the position of the control piston 104 shown in FIG. 2, while maintaining the setting of the setting spring 106, an increase in the force transmitted from the pressure piston 204 to the control piston 104 results in a displacement of the control piston 104 to the left (in the direction of the setting spring 106), which triggers an opening of the second control edge 110 and thus a reduction or relief of the control pressure p_{Steu}. There is then a fluid connection from the control chamber 138 via a third inner radial groove 134 through the radial bores 136 extending through the control piston 104 into the central longitudinal bore 138 extending within the control piston 104 up to and into the characteristic spring chamber 19 and to the tank return 16. A pressure relief of the control pressure p_{Steu} results in a reduction of the force that acts on the control piston control surface 114, that urges the control piston 104 to the left, and that counters a closing of the second control edge 110.

The three hydraulic connections 12, 14, 16 of the valve unit 10 are located at a single planar outer surface of the housing 24, which is advantageous for the attachment or installation in a hydraulic apparatus such as a connection plate 80 of an axial piston machine 70.

The operation of the valve unit 10 in accordance with the invention will now be explained with reference to a description for the setting of a characteristic. FIGS. 4a and 4b for this purpose show two examples for characteristics 300, 310 produced by the valve unit 10 and having a characteristic spring 280 (FIG. 4a) and two characteristic springs 208, 210 (FIG. 4b).

FIG. 4a shows an exemplary characteristic 300 for a valve unit 10 whose second valve 200 only includes one characteristic spring 208. The maximum possible pivot angle αₘₐₓ, i.e. the maximum stroke of the driving mechanism pistons 88 of the regulated axial piston machine 70 (cf. FIG. 6) results from the circumstances of the axial piston machine 70 or from an otherwise present end abutment. On the setting of a specific characteristic, the level of that working pressure p_{A1}, p_{A2} that should be present at the maximum pivot angle αₘₐₓ is specified in the first step by the adjustment of the preload of the setting spring 106 via the setting screw 105. This operating point is also called the working pressure of the regulation start. As can be recognized in FIGS. 2 and 3, the control piston control surface 114 for the control pressure p_{Steu} is oriented such that the force applied by it on the control piston 104 acts against the return force of the setting spring 106.

The pitch of the right straight-line section of the characteristic 300 (there is not yet any force closure via the characteristic spring 208 here) results from the size relationship of the control piston control surface 144 for the control pressure p_{Steu} and the pressure piston control surface 214 for the working pressure pa. With respect to said straight line section, a greater preload of the setting spring 106 while maintaining the stroke results in a characteristic 302 displaced in parallel in the direction of higher working pressures and thus in an increased working pressure for the regulation start p_{A2}.

From a certain pressure level of the working pressure p_{A} or a displacement of the pressure piston 204 by a first distance onward, the compression spring 206 is compressed correspondingly greatly so that the first characteristic spring 208 abuts the blind hole base in the bore 18. After the exceeding of this working pressure threshold value, only a portion of the force that is present due to the application of the working pressure p_{A} to the pressure piston control surface 213 acts on the control piston 104. The other portion of this force results in a contraction of the first characteristic spring 208 that is supported between the pressure piston 204 and the housing 24. This working pressure threshold value consequently characterizes an inflection point of the characteristic 300, 302 since a higher force is required above this working pressure threshold value for a displacement of the control piston 104 by a certain length than below the working pressure threshold value.

The location of the inflection point with respect to the pivot angle or stroke can be varied by the spring rate of the compression spring 206 and/or by the first distance by which the compression spring 206 has to be compressed until the first characteristic spring 208 is in force closure. The pitch of the straight line section at the left side (to the left of the inflection point) belonging to the characteristic 300, 302 is determined first from the size relationship of the control piston control surface 114 for the control pressure p_{Steu} and the pressure piston control surface 214 for the working pressure p_{A} on the pressure piston 204 and, on the other hand, from the spring rate of the first characteristic spring 208.

The greater preload of the setting spring 106, however, not only causes an increase of the regulation start, but rather already results in an additional contraction of the compression spring 206 and thus in a certain displacement of the characteristic inflection point toward somewhat larger pivot angles. FIG. 8 shows, as will be explained more comprehensively further below, an embodiment of the valve unit 10 in accordance with the invention in which the second valve 200 has a screw-in housing 222 having a nut 234 via which screw-in housing 222 a compensation of the preload of the compression spring 206 is possible that results from the setting of the preload at the setting spring 106.

On a solution with two characteristic springs 208, 210, a characteristic 310 312, 214 results having three straight line sections and two inflection points (FIG. 4b) that correspond to those working pressures or displacements of the pressure piston 204 by first and second distances at which the first and second characteristic springs 208, 210 each abut their abutment and enter into a force closure. The previous statements on the parallel displacement of the characteristic 300 toward higher working pressures and the possible compensations apply accordingly to the characteristic 310 of FIG. 4b. A characteristic 310 having two inflection points can be advantageous since with an unchanging maximum pivot angle αₘₐₓ and an unchanging maximum working pressure pₘₐₓ with a larger number of inflection points, the respective characteristic change at these inflection points is less or is abrupt (the relative angle of the straight line sections adjacent to an inflection point becomes larger and the transition therefore becomes gentler when a plurality of characteristic line springs are present). Furthermore, a better approximation of the characteristic 300, 310 to a real hyperbola is achieved by a larger number of characteristic springs or inflection points.

As already presented, the pitch of a straight line section of the characteristic 300, 310 results from the ratio of the control surfaces 114, 214 of the control and pressure pistons 104, 204 (and with straight line sections in which at least one characteristic spring is in force closure, also from the spring constant of the respective characteristic spring). An adjustment of the preload of the setting spring 106 does not, however, change the pitches of the straight line sections. To achieve the latter, provision can be made that the control piston 104 or the unit of control piston 104 and control housing 123 is exchangeable. The control housing 123 and the screw-in housing 122 have to be designed in two parts for this purpose. Differently configured control pistons 104 (in particular having differently shaped control piston control surfaces 114) can thereby be used to further increase the settability of the valve unit 10 in accordance with the invention (in particular to be able to adapt the right straight line section of the characteristic 300, 310 with respect to its pitch.

FIG. 5 shows a longitudinal section through an embodiment of the adjustment device 40 that is designed as a volume flow control valve 40 and to which the control pressure p_{Steu}, the starting parameter of the valve unit 10, is supplied as a hydraulic input parameter at a control connection 52. The valve 40 is integrated in a cartridge-shaped valve housing (a third valve housing 42 in the following) that can be screwed directly into the connection plate 80 of an axial piston machine 70 (cf. FIG. 7) in the embodiment.

The third valve housing 42 has four outer radial grooves 50, 52, 54, 56. The fluid connections are conducted into the respective outer groove 50, 52, 54, 56 to the valve housing 42 by correspondingly arranged bores in the connection plate 80 (of which only the bore to the groove 54 can be seen here). These outer radial grooves 50 52, 54, 56 represent a working connection 50 for the supply of the working pressure pa, a control connection 52 for the provision of the control pressure p_{Steu} produced by the valve unit 10, a first tank connection 56 for the pressure relief of the setting piston 48, and a second tank connection 46 for the leak lead off. There is at least one respective bore penetrating the wall of the valve housing 42 in each of the these outer radial grooves 50, 52, 54, 56 at the groove base to provide the fluid connections to the valve piston 44.

The control pressure p_{Steu} impacts a valve piston control surface 45 that is oriented such that the control pressure p_{Steu} applied thereto exerts a force on the valve piston 44 in the direction of the setting piston chamber 49. In the embodiment shown, the valve 40 and the setting piston 48 are arranged coaxially to one another. The feedback spring 46 acting directly on the pot-shaped valve piston 44 is in force closure with the setting piston 48. The return force acting on the valve piston 44 via this feedback spring 46 is consequently dependent on the position of the setting piston 48 or on the stroke of the driving mechanism pistons 88 so that this compression spring 46 is specifically called a feedback spring.

The valve 40 has a first control edge via which a fluid connection from the working connection 50 in which the pressure level of the working pressure p_{A} is present to a hollow volume of the valve piston 44 (called a feedback spring chamber 47 in the following) and the setting piston chamber 49 adjoining it can be opened. A fluid connection from the first tank connection 54 to the setting piston chamber 49 can be opened via a second control edge, with the working pressure p_{A} being reduced to a setting pressure p_{Stell} present in the setting piston chamber 49 and acting on the setting piston 48. In a central position of the valve piston 44, there is neither a fluid connection between the setting piston chamber 49 and the working connection 50 nor between the setting piston chamber 49 and the first tank connection 54, apart from the leak connection via the second tank connection 56 that is designed such that is only enables very small volume flows. This leak connection extends through only one single radial bore 57 that pierces the wall of the valve piston 44 and that has a constriction facing the feedback spring chamber 47.

The fluid connection from the open control edge extends over a plurality of radial bores 60 piercing the wall of the valve piston 44 into the feedback spring chamber 47 that forms a directly contiguous inner volume with the setting piston chamber 49. A respective comparatively small flow cross-section is also sufficient for the first valve 100 of the valve unit 10 on a maximum opening of its respective control edge 108, 110. It is different with the valve 40. As can be recognized in FIG. 5, a sufficiently fast filling or emptying of the setting piston chamber 49 must be possible over the flow cross-section. For this reason, the fluid connection for the setting pressure p_{Stell} is guided through the wall of the valve piston 44 via a plurality of radial bores 60.

The setting pressure p_{Stell} acts on the total radial cross-sectional surface of the setting piston 48. For the power or torque regulation, a dependence on the working pressure p_{A} and on the piston stroke of the valve piston 44 and on the speed of the axial piston machine 70 must be present, whereas further dependencies should be avoided or compensated, also including an influencing of the position of the valve piston 44 by the setting pressure p_{Stell}. For this reason, the blind hole base of the feedback spring chamber 47 has a continuous bore 59, whereby the control pressure p_{Stell} is also present at the side of the valve piston 44 remote from the setting piston chamber 49.

Both contact surfaces 58 of the setting pressure p_{Stell} naturally have to have the same area at the valve piston 44. Due to the required control surface for the control pressure p_{Steu}, the valve piston 44 at the front side remote from the setting piston chamber 49 has an outer diameter that is smaller than in the longitudinal sections along which the valve piston 44 is guided in the third valve housing 42. So that there is a compensation of the backlash of the setting pressure p_{Sell} on the valve piston 44, its outer diameter has the same outer diameter at the end section facing the setting piston chamber 49 (with the blind hole base of the feedback spring chamber 47 to the contact surface 58 being included).

So that the valve piston 44 can in turn be installed in the valve housing 42, the valve bore in the third valve housing 42 has to have a correspondingly larger diameter at its entry side (at the right in FIG. 5). On the installation of the valve 40, the valve piston 44 is first inserted into the third valve housing 42 and an assembly ring 54 is subsequently installed between the valve piston 44 and the valve housing 42. The installation ring 54 itself is anchored in the third valve housing 42, whereby the setting pressure p_{Stell} acting on it does not exert any influence on the valve piston 44.

FIG. 6 shows a longitudinal section through an embodiment of an axial piston machine 70 in accordance with the invention that comprises a housing 72 and a drive shaft 86 rotatably supported in the housing. A driving mechanism drum in which a plurality of cylinder bores are worked in the manner of a drum revolver in which driving mechanism pistons 88 are axially displaceably supported is seated on the drive shaft 86. The driving mechanism pistons 88 have sliding blocks pivotable via ball joints at their ends not dipping into the cylinder bores. The drive shaft 86 is guided by a swing door 74 (also called a cradle) that is pivotably supported in the housing 72 and that does not co-rotate with the drive shaft 86. The drive shaft 86 is furthermore rotationally fixedly connected to a pivotable retraction plate that urges the sliding blocks of the driving mechanism pistons 88 against the swash plate so that the sliding blocks slide over the front side of the swash plate 74 and the driving mechanism pistons 88 thereby rise and fall about an axis of rotation in parallel with the drive shaft 86. The angle of the retraction plate and thus the stroke of the driving mechanism pistons 84 can be set via the setting of the pivot angle of the swash plate 74 so that the driving mechanism pistons 88 rise and fall in a known manner by a certain distance in their cylinder bores corresponding to the set pivot angle or execute strokes having a certain conveying volume V.

The axial piston machine 70 furthermore has a connection plate 80 having a central drive shaft bore 87. To set the pivot angle of the swash plate 74, a setting lever 76 is connected to its front side. The end of the setting lever 76 opposite the swash plate 74 is connected to the setting piston 48 of the valve 40 that is arranged in a bore 82 of the connection plate 80 (cf. FIG. 7). A displacement of the setting lever 76 by movement of the setting piston 48 results in a pivoting of the swash plate 74. A return spring 78 that exerts a force acting in the direction of the setting piston 48 acts on the rear side of the swash plate 74.

FIG. 7 shows the connection plate 80 of an axial piston machine in accordance with the invention in accordance with an embodiment in a perspective view with a valve unit 10 in accordance with the invention attached to the connection plate 80. The hydraulic connections 90 (working connection A and suction connection S) of the axial piston machine 70 are located at the sides of the connection plate 80 of which one is visible in the perspective representation. The drive shaft bore 87 can likewise be recognized at the rear side of the connection plate 80.

The connection plate 80 has a prepared connection surface 84 for the direct installation of a further axial piston machine 70 at its rear side. Especially with such so-called tandem arrangements, a rearwardly projecting attachment of other components and assemblies, etc. is disruptive so that the valve unit 10 is designed such that it does not project beyond the rear end of the connection plate 80 or the edge of the connection surface 84, but rather projects laterally (at both sides) beyond the end of the connection plate 80.

That bore 82 into which the valve 40 is screwed can be recognized above the bore 87 present for the drive shaft passage. Above this, the connection plate 80 ends with a planar surface that forms the contact surface for the valve unit 10 in accordance with the invention and via which at the same time the three hydraulic connections having the hole pattern compatible with the valve unit 10 (cf. FIG. 2: connections 12, 13, 16) are led out. Further hydraulic valves are installed in a further valve unit 92 above the valve unit 10.

In the embodiment shown, the regulator axles of the valves 100 and 200 are each perpendicular on the drive shaft axle and on the longitudinal axle of the valve 40. The good accessibility of the two setting housings of the valves 100 and 200 or the accessibility of the two valve axles can likewise be recognized. Due to this accessibility, the valves 100, 200 can be installed or replaced as prefabricated assemblies to, for example—as described for the second valve 200—effect a change of the characteristic steepnesses. The good accessibility also allows the attachment of further accesses to effect an operationally variable influencing of the characteristics, e.g. by the attachment of additional actuators such as a proportional magnet, an actuating motor, or a pressure reducing unit or restrictor.

Unlike the embodiment shown in FIG. 2, FIG. 8 shows an embodiment of the valve unit 10 in accordance with the invention in which the preload of the compression spring 206 is manually adjustable from the outside. Due to this possibility, an unwanted displacement of the characteristic inflection point as part of the setting of the regulation start can be corrected. The valve unit 10 is expanded/changed constructionally for such a functional expansion such that a positioning of the screw-in housing 222 of the second valve 200 is provided at different depths of the housing 24 or in the step bore 39.

The fact is important for the understanding of this functional expansion that the screw-in housing 222 does not exert a direct force acting in the axial direction on the pressure piston 204 in any position of its setting range. On the presence of a force closure of the first characteristic spring 208, the screw-in housing 222 exerts an indirect force effect, but no direct force effect, on the pressure piston 204.

The characteristic spring chamber 19 is directly surrounded by a sleeve 223 installed in the housing 24. The sleeve 223 is supported at the front side disposed opposite the screw-in housing 222 via a plate spring stack 224 that lies on a shoulder region of the stepped bore 39. Facing in the radial direction toward the first valve 100, the sleeve 223 extends beyond the free inner region of the plate springs 224. An outer radial groove on which a securing element 232, in particular a securing ring, is applied after the placing on of the plate springs 224 is located at this overhang 225 of the sleeve 223 remote from the characteristic spring chamber 19. The plate springs 224 are supported on the one side on the blind hole base of the housing bore 39 and on the oppositely disposed side on the shoulder region of the sleeve 223. The plate springs 224 consequently do not exert a force effect on any of the two pistons 104, 204 contained in the valve unit 10. The set position of the screw-in housing 222 is fixed by the tightening of a counternut 234.

For a preferable method of installation of the valve unit 10, the compression spring 206 is first fastened by one of its end windings to the pressure piston 204. The first characteristic spring 208 is subsequently fastened to the pressure piston 204. The spring plate 212 is subsequently placed onto the oppositely disposed end winding of the compression spring 206. The sleeve 223 equipped therewith and the screw-in housing 222 are then connected to one another via shape matching, that is also achieved here by a swept end contour and a flange 226, and are inserted into the housing 24 or into the conical stepped bore 39.

The second valve 200 can also be installed in and removed from the housing 24 as a premounted unit in such an embodiment due to this design and this installation sequence. Compression springs and characteristic springs differing in length and in spring rate can also be provided for this purpose to have a modular system in this manner by which a torque or power regulation having different characteristics can be provided.

The screw-in housing 222 and the sleeve 223 can alternatively be produced in one piece. Said parts are, however, preferably produced separately and are connected to one another via shape matching 226 before the installation into the housing 24.

So that the fluid connection required for the leak leading off is present over the total setting range of the screw-in housing 222, a radial bore 230 piercing the sleeve wall impacts an outer radial groove 222 that is formed in the sleeve 223 and that has a correspondingly wide extent in the axial direction to always cover the bore of the tank connection 16 in the different possible positions within the stepped bore 39.

A functional expansion that goes beyond the possibility of a displacement of the characteristic inflection point carried out manually from the outside is an operationally variable adjustability. While maintaining the basic design, this is possible in that, for example, a plunger is led through a central longitudinal bore in the screw-in housing 222 that can e.g. apply an additional force on the pressure piston 204 in the direction of the control piston 104 via an actuator such as a proportional magnet or an actuating motor. A limitation of the leak along the intermediate space from the outer plunger wall to the plunger bore naturally has to be achieved here as well as a corresponding leak lead-off.

To be able to dispense with such a seal against the working pressure p_{A} in this region, the pressure piston 40 can alternatively be designed as a stepped piston and the pressure piston control surface 214 for the working pressure p_{A} can be provided at the step of the jacket surface of the pressure piston 204.

In the embodiments of FIGS. 2 and 8, the setting of the regulation start in the first valve 100 takes place by the preload of the setting spring 106. This can be manually predefined from the outside via the setting screw 105. Alternatively to such a mechanism, however, an actuator such as a proportional magnet or an actuating motor, etc. could also be fastened to the valve arrangement of the first valve 100 here and the corresponding force effect could be applied to the control piston 104 or to an element replacing the setting screw 105 by a plunger fastened to it.

The use of a pressure reducing unit represents a further alternative. The valve 100 has to be equipped with a further control surface in this respect. An increase in the construction length of the valve unit 10 is avoided by the use of a pressure reducing unit. Such a pressure reducing unit could also be provided for the second valve 200.

The two aforesaid alternatives have the advantage that the regulation start is operationally variable, i.e. can also be varied during operation and in so doing even permanently.

With correspondingly high volumes, such an expansion of the connection plate 80 can be sensible such that the valve unit 10 is accommodated in the connection plate 80 and a separate housing 24 for the valve unit 10 can be dispensed with.

The present invention inter alia provides the following advantages:

On the one hand, a simple handling in the installation and adjustment results:
dispersed construction, lateral access to the valves 100 and 200 and thus good accessibility of the setting (adjustment screws or actuators);
simple adjustment of the regulation start via the first valve 100;
further influencing of the characteristic 300, 310 substantially via the second valve 200;
an approximately separate settability of the regulation start and of the pitch of the characteristic 300, 310 or of the pitch of the first straight line section (i.e. the straight line section having a comparably high working pressure a comparatively small pivot angle of the characteristic) and the characteristic inflection point are present;
a cartridge construction can be used for each of the three valves 100, 200, 40. An installation of the total power regulation system in accordance with the invention via preinstalled valves is thus possible.

In addition, the total design has a small extent in the longitudinal direction of the axial piston machine 70 and is therefore particularly well suited for tandem arrangements of a plurality of axial piston machines 70.

The common leak return of both valves 100, 200 of the valve unit 10 in accordance with the invention via a common tank connection 16 is also advantageous.

An advantageous modularity of the valve unit 10 in accordance with the invention or of the power regulation system in accordance with the invention moreover results.
The previously addressed cartridge construction enables a simple replacement of all the valves 100, 200, 40. The possibility is hereby provided for the second valve 200 of equipping such valves 200 with different characteristic springs and of keeping them in stock. An adaptation of the characteristic 300, 310 for the power or torque regulation is thus possible by a preinstalled second valve 200.
The apparatus can be designed while maintaining many of the same parts in different configuration levels:
   in a simpler embodiment, an adaptation of a spring preload that can be carried out from the outside is not possible, i.e. there is no possibility of an external adjustment of the regulation start and/or no possibility of an external displacement of the characteristic inflection point;
   In an already more flexible embodiment, an adaptation of a spring preload that can be carried out from the outside is possible, i.e. there is a possibility of an external adjustment of the regulation start and/or of an external adjustment of the characteristic 300, 310;
   in an even more flexible embodiment, the control piston 104 of the first valve 100 and/or of the pressure pistons 204 of the second valve 200 can be influenced by an externally supplied control parameter during the operation, for example by a correspondingly attached proportional magnet or actuating motor that exerts a force on the control and/or pressure pistons 104, 204 via a plunger, e.g. by use of a further control surface that is acted on by a pressure level provided by means of a pressure reducing unit.

Since the invention, on the one hand, only relates to the valve unit 10, it is possible to use it or to simply retrofit it in existing systems having existing adjustment devices (e.g. similar to the volume flow control valve 40) for the power or torque regulation of an axial piston machine 70. In combination with the valve 40, the power regulation system in accordance with the invention is produced that can likewise be retrofitted in existing axial piston machine 70.

### REFERENCE NUMERAL LIST

10 valve unit

12 working connection

14 control connection

16 tank collection

18 bore

19 characteristic spring chamber

20 cutout

21 longitudinal bore

22 first restrictor

23 radial bore

24 housing

30 hydraulic tank

32 closure element

34 seal

36 support ring

38 first stepped bore

39 second control edge

40 adjustment device

42 third valve housing

44 valve piston

45 valve piston control surface

46 feedback spring

47 feedback spring chamber

48 setting piston

49 setting piston chamber

50 working connection

52 control connection

54 first tank connection

56 second tank connection

57 radial bore

58 contact surface

59 bore

60 radial bore

70 axial piston machine

72 housing

74 swash plate

76 setting lever

78 return device

80 connection plate

82 bore

84 connection surface

86 drive shaft

87 driving mechanism bore

88 driving mechanism piston

80 hydraulic connection

92 further valve unit

100 first valve

102 first valve housing

104 control piston

105 setting screw

106 setting spring

107 setting spring chamber

108 first control edge

110 second control edge

114 control piston control surface

121 nut

122 screw-in housing

123 control housing

124 radial groove

126 directional bore

128 inner radial groove

130 inner radio groove

132 control chamber

134 inner radial groove

136 radial bore

138 longitudinal bore

140 longitudinal bore

141 closure element

142 radial bore

144 annular space

146 radial bore

148 annular space

150 setting spring carrier

152 flange

200 second valve

202 second valve housing

203 overhang

204 pressure piston

206 elastic element (compression spring)

208 first characteristic spring

210 second characteristic spring

212 spring plate

214 pressure piston control surface

218 outer radial groove

220 directional bore

222 screw-in housing

223 sleeve

224 plate spring stack

225 continuation

226 flange

228 outer radial groove

230 radial bore

232 securing element

234 nut

300 characteristic (a characteristic spring)

302 characteristic (a characteristic spring)

310 characteristic (two characteristic springs)

312 characteristic (two characteristic springs)

314 characteristic (two characteristic springs)

αₘₐₓ maximum pivot angle of the swash plate

A working connection

K further force/forces

p_{A} working pressure

p_{A1} working pressure of the regulation start

p_{A2} working pressure of the regulation start

pₘₐₓ maximum working pressure

p_{Steu} control pressure

p_{Stell} setting pressure

S suction connection

Vₘₐₓ maximum conveying volume of the axial piston machine

Vₘᵢₙ minimum conveying volume of the axial piston machine

1. A hydraulic valve unit (10) for the power or torque regulation of an axial piston machine (70) comprising a first valve (100) having a control piston (104) displaceably supported in a first valve housing (102), and a second valve (200) having a pressure piston (204) displaceably supported in a second valve housing (202), wherein
a working pressure (p_{A}) applied to a working connection (12) can be reduced by the valve unit (10) in dependence on the position of the control piston (104) to a control pressure (p_{Steu}) applied to a control connection (14),
the control piston (104) is preloaded by a setting spring (106) arranged in the first valve (100), the first and second valves (100, 200) are arranged coaxially to one another, and
the control piston (104) and the pressure piston (204) are connected to one another by force transmission by an elastic element (206) adapted to transmit a force acting on the pressure piston (204) to the control piston (104), with furthermore a first characteristic spring (208) for generating a characteristic (300, 310) for the power or torque regulation) preferably being arranged coaxially to the elastic element (206), said power or torque regulation being adapted to exert a force from a displacement of the pressure piston (204) by a first distance onward.

2. A valve unit (10) in accordance with claim 1, wherein the elastic element (206) is a spring having an in particular smaller spring constant than the first characteristic spring (208) fastened to the pressure piston (205) and preferably urges a spring carrier (212) toward the control piston (104).

3. A valve unit (10) in accordance with claim 1, wherein the first characteristic spring (208) is arranged around the elastic element (206) and is guided within a first bore (214) whose depth is greater than the length of the relaxed first characteristic spring (208), with the first characteristic spring (208) contacting the base of the first bore (18) on a displacement of the pressure piston (204) by the first distance, and with the first bore (18) preferably having a central cutout (20) by which the elastic element (206) and/or the control piston (104) is/are guided.

4. A valve unit (10) in accordance with claim 1, wherein a second characteristic spring (210) is arranged between the control piston (104) and the pressure piston, (204) said second characteristic spring (210) contributing to the generation of the characteristic (310) for the power or torque regulation and being adapted to exert a force from a displacement of the pressure piston (204) by a second distance onward, with the second distance being longer than the first distance, and with the second characteristic spring (210) preferably being arranged coaxially to the first characteristic spring (208) and/or to the elastic element (206).

5. A valve unit (10) in accordance with claim 1, wherein the pressure piston (204) has a pressure piston control surface (214) at which the working pressure (p_{A}) is applied and exerts a force in the direction of the control piston (104), with a first restrictor (22) for reducing pressure fluctuations at the pressure piston control surface (214) being arranged between the pressure piston control surface (214) and the working connection (12).

6. A valve unit (10) in accordance with claim 1, wherein the control piston (104) has a control piston control surface (114) to which the control pressure (p_{Steu}) is applied and exerts a force in the direction of the setting spring (106).

7. A valve unit (10) in accordance with claim 1, wherein the reduction of the working pressure (p_{A}) to the control pressure (p_{Steu}) is determined by the position of the control piston (104), with the control piston (104) having a first control edge (108) that permits a hydraulic fluid flow from the working connection (12) to the control connection (14) on an opening and that preferably closes on a certain displacement of the control piston (104) in the direction of the setting spring (106) onward.

8. A valve unit (10) in accordance with claim 1, wherein a common tank connection (16) is provided via which hydraulic fluid leaks of both valves (100, 200) can be led off to a hydraulic tank (30), with the tank connection (16) preferably being connected to a characteristic spring chamber (19) in which the elastic element (206) and/or the first characteristic spring (208) is/are stored.

9. A valve unit (10) in accordance with claim 8, wherein the setting spring (106) is stored in a setting spring chamber (107) that is connected to the tank connection (16) via a longitudinal bore (138) extending in the control piston (104), with the longitudinal bore (138) extending as a blind hole bore from the end facing the characteristic spring chamber (19) in the control piston (104), and with a first radial or directional bore (146) being provided in the control piston (104) that opens from its outer side into the longitudinal bore (138) and that preferably comprises a second restrictor or is configured such that it exerts a restrictive effect.

10. A valve unit in accordance with claim 8, wherein the control piston (104) has a second control edge (110) that permits a hydraulic fluid flow from the control connection (14) to the tank connection(16) on an opening, preferably via a longitudinal bore (138) extending in the control piston (104) and at least one second radial or directional bore (138) starting from the longitudinal bore.

11. A valve unit (10) in accordance with claim 1, wherein the first and second valves (100, 200) are arranged in a common housing (24), with the first valve (100) preferably being arranged in a first conical bore (38), in particular a stepped bore, and the second valve (200) preferably being arranged in a second conical bore (39), in particular stepped bore and being able to be introduced into the housing (24) from the outside, in particular screwable by a screw-in housing (122, 222).

12. A valve unit (10) in accordance with claim 11, wherein the first and second valves (100, 200) can be installed in the housing (24) as premounted assemblies and are preferably designed in cartridge form.

13. A valve unit (10) in accordance with claim 1, wherein the preload of the setting spring (106) is variable, with the first valve housing (102) preferably comprising a setting screw (105) to which the setting spring (106) is fastened, with the distance of the setting screw (105) from the second valve (200) being variable by screwing the setting screw (105) into or out of a threaded bore of the first valve housing (102), with the setting screw (105) in particular being fixable by a nut (121).

14. A valve unit (10) in accordance with claim 1, wherein the second valve housing (202) is configured such that its distance from the first valve (100) is not variable.

15. A valve unit (10) in accordance with claim claim 1, wherein the first and/or second valve housings (102, 202) is/are or comprises/comprise a screw-in housing (222) that is configured such that the distance of the screw-in housing (222) is adjustable and is in particular fixable by a nut (234), with the characteristic (300, 310) for the power or torque regulation being variable by adjusting the distance of the screw-in housing (22) from the other valve (100), in particular with a change of the preload of the setting spring (105) being able to be compensated.

16. A valve unit (10) in accordance with claim 1, wherein the working pressure (p_{A}) is supplied to both the control piston (104) and to the pressure piston (204).

17. A valve unit (10) in accordance with claim 1, wherein a first pressure generation means is provided by which an additional, settable pressure can be exerted on the control piston (104), with the first pressure generating means preferably comprising a control surface of the control piston (104), a pressure reducing unit, and/or an actuator, in particular a proportional magnet or actuating motor.

18. A valve unit (10) in accordance with claim 1, wherein a second pressure generation means is provided by which an additional, settable pressure can be exerted on the control piston (204), with the second pressure generating means preferably comprising a control surface of the control piston (204), a pressure reducing unit, and/or an actuator, in particular a proportional magnet or actuating motor.

19. A valve unit (10) in accordance with claim 1, wherein the elastic element (206) is a characteristic spring having a non-linear spring constant.

20. A hydraulic power regulation system for an axial piston machine (50) comprising a valve unit (10) in accordance with claim 1 and a hydraulic adjustment device (40) to which the control pressure (p_{Steu}) produced by the valve unit (10)9 is applied as an input parameter, with the adjustment device (40) preferably being a volume flow control valve or a volume flow regulation valve.

21. A power regulation system in accordance with claim 20, wherein the adjustment device (40) has a valve piston (44) that is displaceably supported in a third valve housing (42) and to which the control pressure (p_{Steu}) is applied, with the valve piston (44) being connected with force transmission to a displaceably supported adjustment piston (48), in particular via a feedback spring (46).

22. A power regulation system in accordance with claim 21, wherein the adjustment device (40) has a working connection (50) to which the working pressure (p_{A}) is applied, with the working pressure (p_{A}) being reducible to a setting pressure (p_{Sell}) by the adjustment device (40) in dependence on the position of the valve piston (44), which setting pressure (p_{Stell}) is applied to the setting piston (48) and exerts a force directed away from the valve piston (44) on it, and with the setting pressure (p_{Stell}) preferably being applied to both sides of the valve piston (44) independently of the amount of the setting pressure (p_{Stell}).

23. A power regulation system in accordance with claim 20, wherein the first and second valves (100, 200) of the valve unit (10) and the adjustment device (40) are arranged in a common housing part, in particular a connection plate (80) of an axial piston machine (70), with the longitudinal axes of the first and second valves (100, 200) preferably being oriented perpendicular to the longitudinal axis of the adjustment device (40).

24. An axial piston machine (70), in particular an axial piston motor or an axial piston pump, having a power regulation system in accordance with claim 20 and comprising a swash plate (74) pivotably supported in a housing (72) of the axial piston machine (70), a setting lever (76) connected to the swash plate (74) at its front side for the adjustment of the pivot angle of the swash plate (74), and a return device (78), in particular a return spring, that is arranged on the rear side of the swash plate (74) and that exerts a force on the swash plate (74), with the end of the setting lever (76) disposed opposite the swash plate (74) being connected to the setting piston (48) of the adjustment device (40).

25. An axial piston machine (70) in accordance with claim 24, comprising a connection plate (80), with the adjustment device (40) being arranged in a bore (82) of the connection plate (80) and preferably being designed in cartridge form, with the valves (100, 200) of the valve unit (10) being arranged in a housing (24) installed at the connection plate (80) or in the connection plate (80), and with the housing (24) or the connection plate (80) preferably being configured such that the valve unit (10) does not project beyond a connection surface (84) formed at a rear side of the connection plate (80) remote from the swash plate (74) so that a second axial piston machine can be installed at the connection surface (84) over its connection surface for forming a tandem arrangement having a common drive shaft.

26. A mobile working machine having at least one axial piston machine (70) in accordance with claim 24.
